(19) United States
(12) Patent Application Publication
(10) Pub. No.: US 2025/0024892 A1
(43) Pub. Date: Jan. 23, 2025

(54) DISPLAY CONTROL FOR AEROSOL-GENERATING DEVICE AND SYSTEM

(71) Applicant: NICOVENTURES TRADING LIMITED, London (GB)

(72) Inventors: Mohammed AL-AMIN, London (GB); Dominic WOODCOCK, London (GB)

(21) Appl. No.: 18/713,529

(22) PCT Filed: Nov. 8, 2022
(86) PCT No.: PCT/GB2022/052822

§ 371 Date: May 24, 2024

(30) Foreign Application Priority Data
Nov. 26, 2021 (GB) 2117069.1

(51) Int. Cl. A24F 40/60; A24F 40/40; A24F 40/51; G06F 3/147

(52) U.S. Cl. CPC A24F 40/60; A24F 40/40; A24F 40/51; G06F 3/147

(57) ABSTRACT

A non-combustible aerosol-generating device id disclosed. It comprises a display for displaying a predetermined image visible to a user on activated regions of the display, and control circuitry configured to detect an orientation of the aerosol-generating device, and to control the display such that a predetermined image is displayed based on said detected orientation. A non-combustible aerosol-generating system comprising a non-combustible aerosol-generating device according to the invention is also disclosed together with a method of controlling the non-combustible aerosol-provision device.

### TECHNICAL FIELD

The present specification relates to a non-combustible aerosol-generating device, to a non-combustible aerosol-generating system, and to a method of controlling a non-combustible aerosol-generating device.

### BACKGROUND

Smoking articles, such as cigarettes, cigars and the like burn tobacco during use to create tobacco smoke. Attempts have been made to provide alternative delivery devices to these articles by creating products that release compounds without combustion. Examples of such delivery devices are so-called “heat not burn” products or tobacco heating devices or products, which release compounds by heating, but not burning, a substrate. For example, tobacco heating devices heat an aerosol generating substrate, which may be tobacco or other non-tobacco products which may or may not contain nicotine, to form an aerosol by heating the substrate without burning it.

### SUMMARY

According to an aspect of the invention, there is provided a non-combustible aerosol-generating device, comprising: a display for displaying a predetermined image visible to a user on activated regions of the display, and control circuitry configured to detect an orientation of the aerosol-generating device, and to control the display such that a predetermined image is displayed based on said detected orientation.

The control circuitry may comprise a sensor to detect an orientation of the device. It may also include a display driver configured to receive a signal from the sensor indicative of said detected orientation and to display a predetermined image based on the signal received from the sensor. The sensor may be an accelerometer, or it may be an accelerometer coupled to a gyroscope.

The sensor and the display driver can be configured to maintain the orientation of a predetermined image being displayed, irrespective of a change to the orientation of the device.

The display driver may be configured to change a predetermined image being displayed for another predetermined image, based on a detected change in the orientation of the device.

The display driver can be configured to deactivate the display when the device remains in the same orientation for a predetermined period of time. In this instance, the display controller may be configured to reactivate the display, to display a predetermined image based on said detected orientation of the device, when the orientation of the device changes from said same orientation.

The control circuitry can also be configured to detect activated regions of the display that have been covered, and to deactivate said regions.

In some embodiments, the control circuitry may be configured to move images previously visible on activated regions of the display prior to deactivation of said regions, to another, exposed, region of the display.

The display may be a touch sensitive display. In this instance, the control circuitry may be configured to deactivate regions of the display being touched.

The display can be a light sensitive display. The control circuitry can then be configured to deactivate regions of the display when a predetermined minimum light level has been sensed.

In some embodiments, the device may comprise a second display for displaying an image visible to a user on activated regions of said second display.

If another display is provided, the display driver can be configured to move images previously visible on activated regions of the display, prior to deactivation of said display in response to being covered, to said second display.

The control circuitry may be configured to completely deactivate the display when activated regions of the display are covered, such that images are displayed only on the second display.

The control circuitry may be configured to detect activated regions of the second display that are covered, and to deactivate said covered regions of the second display.

In some embodiments, the second display can be a touch sensitive display. The control circuitry can then be configured to deactivate regions of the second display being touched.

Alternatively, the display can be a light sensitive display. The control circuitry can then be configured to deactivate regions of the display when a predetermined light level has been sensed.

According to another aspect of the invention, there is provided a non-combustible aerosol-generating device, comprising: a display for displaying an image visible to a user on activated regions of the display, and control circuitry to control the display, wherein the control circuitry is configured to detect activated regions of the display that are covered, and to deactivate said regions.

It will be understood that a non-combustible aerosol provision device that has control circuitry adapted to detect regions of the display that are covered, may or may not also be able to change the display based upon device orientation.

In any embodiment, the device may comprise a housing having an outer surface. The display may be attached to the outer surface.

The outer surface of the housing may comprise a contoured shape and the display can be configured so that it conforms to the contoured shape of the outer surface of the housing.

The housing can be tubular and the outer surface may extend about a longitudinal axis for at least 90 degrees, at least 180 degrees or 360 degrees.

The display may also extend in a longitudinal direction for substantially the entire length of the housing.

The control circuitry may comprise a memory to store predetermined images to be displayed.

The display may be configured to display an image comprising at least one of a solid colour, a pattern, an animation or a graphic. The image may be a static image and/or a moving image.

The display or displays may be an OLED, flexy TFT, display, OLCD, e-ink (or EPD), AMOLED or PMOLED display. Not all the displays may be of the same type.

According to another aspect of the invention, there is provided a non-combustible aerosol-generating system comprising a non-combustible aerosol-generating device according to the invention, and a non-combustible aerosol-generating article receivable in the non-combustible aerosol-generating device.

According to another aspect of the invention, there is provided a method of controlling a non-combustible aerosol-provision device comprising: control circuitry to control a display for displaying a predetermined image visible to a user on activated regions of the display, detecting an orientation of the device, and controlling the display to display a predetermined image based on said detected orientation.

### BRIEF DESCRIPTION OF THE DRAWINGS

Embodiments of the invention will now be described, by way of example only, with reference to the accompanying drawings, in which:

FIG. 1 is a perspective view of an example of a non-combustible aerosol-generating device for heating smokable material according to an embodiment of the present invention;

FIG. 2 shows a longitudinal cross-sectional view of the device shown in FIG. 1;

FIG. 3 shows a simplified cross-sectional view of the device shown in FIGS. 1 and 2, taken along line A-A, according to some embodiments;

FIG. 4 shows a simplified cross-sectional view of the device shown in FIGS. 1 and 2, taken along line A-A, according to some other embodiments;

FIG. 5 illustrates the steps involved in a method of controlling a non-combustible aerosol-generating device according to an embodiment of the invention; and

FIG. 6 illustrates the steps involved in a method of controlling a non-combustible aerosol-generating device according to another embodiment of the invention.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping system or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine.

In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable, such as an article, for use with the non-combustible aerosol provision device. An aerosol-generating material is a material that is capable of generating aerosol, for example when heated, irradiated or energized in any other way. An aerosol-generating material may be in the form of a solid, liquid or gel which may or may not contain an active substance and/or flavourants.

In some embodiments, the non-combustible aerosol provision device 1 may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

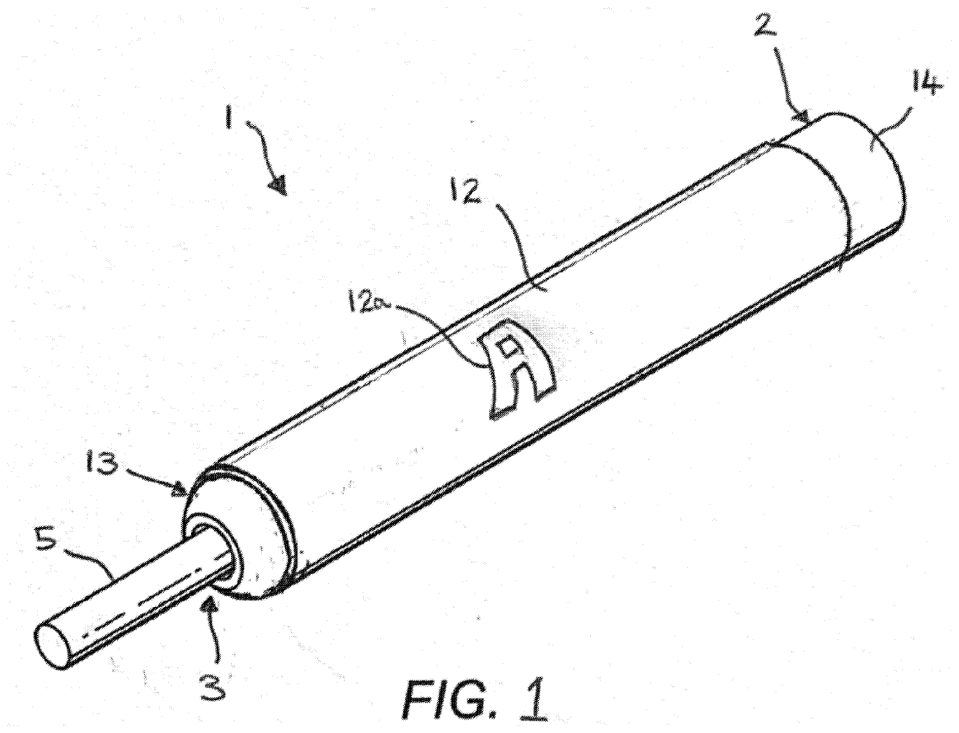

Referring to FIG. 1, there is shown a perspective view of an example of a non-combustible aerosol-generating system, comprising a device 1 and an article 5 received in the device 1. The device 1 is arranged to heat smokable material to volatise at least one component of the smokable material for inhalation by a user. The non-combustible aerosol-generating device 1 is a so-called “heat-not-burn” device 1. The device 1 in this example has a generally elongate cylindrical outer housing 2 of circular cross-section. The outer housing 2 has an open end 3, also referred to as the mouth end. The outer housing 2 may be formed of a heat insulating material. A particularly suitable material is polyether ether ketone (PEEK), though other plastics, including for example acrylonitrile butadiene styrene (ABS), or other heat insulating materials, may be used. The outermost surface of the outer housing 2 may have a decorative coating, such as a metallic finish.

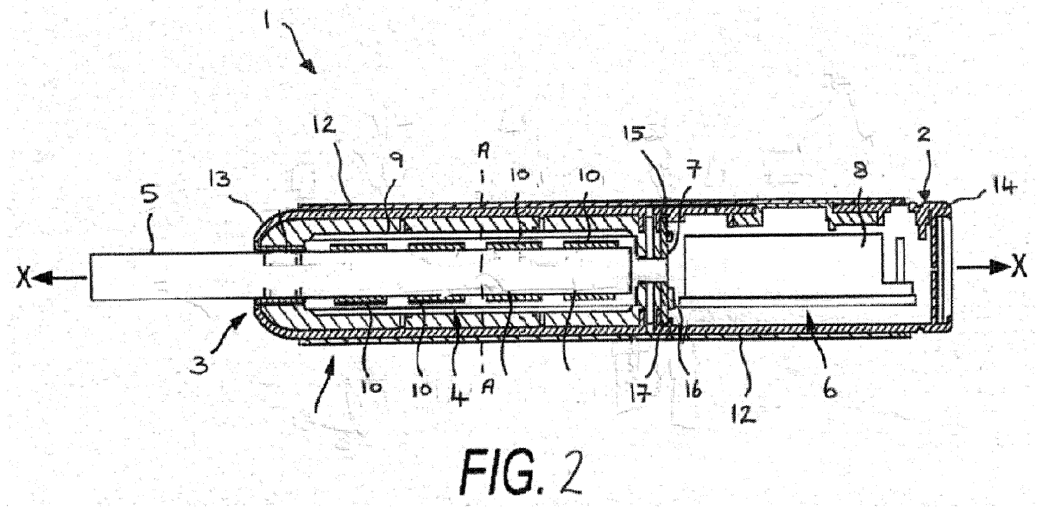

FIG. 2 shows a longitudinal cross-sectional view of the device 1 for heating a smokable material 5, shown in FIG. 1. The device 1 can therefore be considered to be formed of two main components; a device part or aerosol-generating device 1, and a consumable part or aerosol-generating article, generally denoted by smokable material 5. The device part 1 and consumable part 5 are engageable with one another (as shown in FIGS. 1 and 2) such that the consumable part 5 may be engaged with/inserted into the device part 1. The device 1 has a heating chamber 4 which in use contains the smokable material 5 to be heated and volatised. The smokable material 5 may be in the form of a consumable article, which can be removably inserted into the open end 3 of the device 1 by a user. The article 5 may be a generally elongate cylinder, such as a rod. In use, the article 5 is inserted into the housing 2 such that an end of the article 5 projects out of the device 1 through the open end 3 of the housing 2, and such that a user can place their lips over the article 5 in order to inhale an aerosol generated by the device 1.

The device 1 comprises an electronics/power chamber 6 containing electrical control circuitry 7 and a power source 8. In this example, the heating chamber 4 and the electronics/power chamber 6 are adjacent to each other along the longitudinal axis X-X of the device 1. The electrical control circuitry 7 may include a controller, such as a microprocessor arrangement, configured and arranged to control the heating of the smokable material 5, and incorporates a display driver 15 for controlling images appearing on a display or displays that form part of the device 1, as will be described in more detail below.

The electrical control circuitry 7 may in use receive a signal from, for example, a puff-actuated sensor (not shown) which is sensitive to for example changes in pressure or changes in rate of air flow that occur upon initiation of a draw on the smokable material article 5 by a user. The electrical control circuitry 7 can then operate so as to cause heating of the smokable material article 5 “on demand” when required. Various arrangements for a puff-actuated sensor are available, including for example a thermistor, an electro-mechanical device, a mechanical device, an optical device, an opto-mechanical device and a micro electro mechanical systems (MEMS) based sensor. As an alternative, the device 1 may have a manually operable switch for a user to initiate a puff.

The power source 8 may be a battery, which may be a rechargeable battery or a non-rechargeable battery. Examples of suitable batteries include for example a lithium-ion battery, a nickel battery (such as a nickel-cadmium battery), an alkaline battery and/or the like. A particularly preferred type of battery 8 is a LiFePo4 battery. The battery 8 is electrically coupled to the one or more heating elements 10 of the heating chamber 4 to supply electrical power when required and under control of the electrical control circuitry 7 to heat and volatize the smokable material 5 without causing it to burn. In this example, the battery 8 is contained within a printed circuit board of the electrical control circuitry 7. In other examples, the battery 8 and the electrical control circuitry 7 may be arranged differently, such as for example arranged adjacent each other along the longitudinal axis X-X of the apparatus 1.

The heating chamber 4 is contained within a heater support sleeve 9, which is contained within the outer housing 2. In this example, the heater support sleeve 9 is a generally elongate cylinder of circular cross-section. In an example, the heater support sleeve 9 is a double-walled or “vacuum” sleeve, having an outer cylindrical wall and an inner cylindrical wall which are joined to each other at each end.

In one example of the device 1, the heater support sleeve 9 contains plural heating elements or heater segments 10. In this example, the heater segments 10 align along or parallel to the longitudinal axis X-X of the heater support sleeve 9. The electrical control circuitry 7 is configured to supply power to the heater segments 10 to heat the smokable material article 5.

The device 1 in accordance with an embodiment of the present invention shown in FIGS. 1 and 2, comprises a display 12 for displaying an image 12a (represented by the letter “A” in FIG. 1), which is visible to a user on activated regions of the display 12.

Whilst the display 12 is shown proud of the housing 2 in the FIGS. 1 and 2, it will be understood that the display 12 may be recessed into the housing 2, and can be flush with the outer surface of the housing 2 to give the appearance that it is integrally formed with the housing 2. Integration of the display 12 around the device 1, and recessing the display 12 into the surface of the housing 2, may allow the device 1 to have shape similar to a conventional device and so maintain user familiarity.

By “inactivated regions” is meant those regions of the display 12 which are not displaying an image and so are switched off or are inactive. When the device 1 is completely switched off and nothing is being displayed, the entire display 12 may be considered to form an inactive region. When the device 1 is active, and images 12a are being displayed on part of the display 12, the remainder of the display 12 which is not showing an image 12a is considered to be the inactive region or regions.

As shown in FIG. 1, the display 12 may wrap or extend about the housing 2 and so that it closely conforms to the contours of the housing 2. Ideally, the display 12 will at least give the appearance of forming a part of the housing 2, rather than a separate component, even if the display 12 is applied or wrapped about the housing 2 during manufacture. The display 12 may be flexible to enable it to be manipulated so that it assumes or mimics the contours of the outer surface of the housing 2 during manufacture and assembly.

The display 12 may extend about the longitudinal axis of the housing 2 for any angle. However, the display 12 preferably extends about the housing 2 for at least 90 degrees, at least 180 degrees or 360 degrees, as shown in FIG. 1. The display 12 may also extend in a longitudinal (X-X) direction for the entire, or substantially the entire, length of the housing 2 so that the housing 2 is completely covered, or at least a major portion of the housing 2 is covered, by the display 12. However, there may be areas that are not covered by the display 12, such as a mouthpiece, or an on/off button. In FIGS. 1 and 2, substantially the entire length of the device 1 is covered by the display 12, only short sections 13, 14 of the housing remaining uncovered by the display 12 at opposite ends of the device 1.

FIG. 3 shows a simplified cross-sectional view taken along line A-A in FIG. 2, at right angles to the longitudinal axis X-X, and showing the housing 2 and the display 12 wrapped around the housing 2. The display 12 is shown oversized for clarity. As can be seen in FIG. 3, a single screen extends around the housing 2 for 360 degrees, so that each end 12b of the display 12 meet.

In certain circumstances, the display 12 may be resiliently flexible such that a mechanical or pressure sensitive button, i.e. an on/off button, located beneath the display 12 may be activated by applying pressure to the display 12 to temporarily deform the display 12 and, in turn, apply pressure to the button to activate it.

Graphics or other images or indicia may appear on the display 12 to indicate to the user the location and/or status of the button located beneath the display 12. The graphics or images may change once the button has been activated. The display 12 may be a flexible display 12 to facilitate formation of the curved viewing surface. In particular, the flexible display 12 may be flexed to provide the curved viewing surface. Once the display 12 is fixed or otherwise coupled to the housing 2, the display 12 may no longer be capable of flexing, for example, when the display 12 is at least partially or entirely attached to the housing 2.

In another embodiment, the display 12 forms an integral part of the housing 2, i.e. the display 12 and the housing 2 are a single integrated component such that the display 12 carries out the dual function of displaying images as well as defining the structural housing containing the components of the system 1, and so the display 12 itself forms the outer surface of the device 1.

The display 12 may be powered by the device battery 8. Alternatively, the display 12 may have its own, separate, power source such as another rechargeable battery (not shown) which is received within the housing 2. The device battery 8 and the display battery may be rechargeable together or independently from each other. The display 12 may be kept ‘on’ by default, only switching off when, for example, power becomes low, or the device 1 hasn't been used for a longer period of time, particularly if a display 12 requiring minimum power is used, such as a e-ink type display.

In some embodiments, there can be more than one display 12, located elsewhere on the device, i.e. there may be two side-by-side displays 12. If a second, or further, display is provided, it may have the same or a similar construction to the first display 12.

The images 12a displayed on the or each of the first and second displays 12 may be controlled via the display driver 15 of the control circuitry 7 so that there is some association between the displayed images, i.e. a moving image may initiate on one of the displays 12 to complement a different moving image on another display 12, to provide an appealing and interesting overall appearance. Alternatively, one of the displays 12 may be used primarily to provide the user with feedback or information relating to the status of the device 1, whereas another display 12 may be used to show a graphic or image.

Each of the displays 12 may extend or wrap about the longitudinal axis (X-X) for at least 90 degrees, at least 180 degrees or 360 degrees to provide a curved and/or contoured viewing surface. Each of the second displays 12 may extend longitudinally (X-X) for at least part of the length of the housing 2.

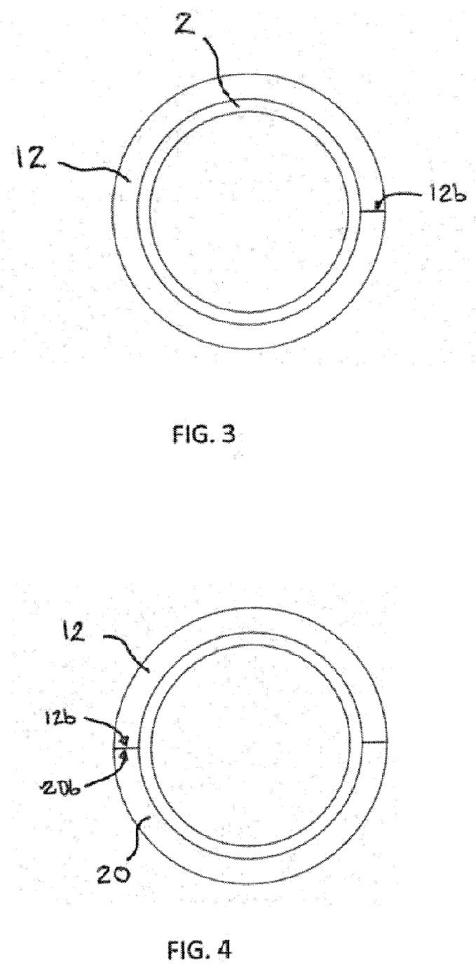

FIG. 4 shows a simplified cross-sectional view taken along line A-A in FIG. 2, at right angles to the longitudinal axis X-X, according to a multiple display embodiment. In FIG. 4, there are two displays wrapped around the housing. The first display 12, extends around the housing for 180 degrees and the other display 20 extends around the housing 2 for the remaining 180 degrees. Corresponding ends of each display 12, 20 meet, although it will be appreciated that there can be a gap between facing ends 12b, 20b of each display 12, 20.

The display driver 15 of the control circuitry 7 may be configured to control the, or each, display 12 to display predetermined images on the, or each, display 12.

The control circuitry 7 may comprise a memory 17 to store predetermined images to be displayed on the, or each, display 12.

It will be understood that the images displayed by the or each display display 12 may include, comprise or consist of at least one of a solid colour, a pattern, an animation, a graphical representation or any text or other indicia.

In certain embodiments, the control circuitry 7 may be configured to control the displays so that one of the displays 12 displays static images, whilst another displays a moving image. Any suitable static image may be an image displayable on the display 12. The static image may include a cartoon-like image or a realistic image. The static image may be displayed in colour on part of all the display 12.

Any suitable motion image may be an image displayable on the display(s) 12. A motion image may appear as continuous movement or changes in the display 12. For example, brightness or the colour of various pixels may change. The motion image may include a cartoon-like image, a live action image, or a life-like action image (for example, using computer generated graphics).

If more than one display 12 is provided, they can be of the same type. However, each of the displays, or some of the displays 12 may be of a different type. For example, at least one of the displays can be an OLED, flexy TFT, display, OLCD, e-ink (or EPD), an AMOLED (active-matrix organic light-emitting diode display), or a PMOLED display. The type of display 12 will depend on the nature of the images to be displayed.

The display or displays 12 may include a plurality of pixels, for example, arranged into an array that are capable of forming images. The display(s) 12 may be used to show various images at different times. The images may be static images or motions images, which may be a series of static images or an encoded motion image. The display(s) 12 may show one or more viewable elements, selectable elements, and colours. The display 12 may be a colour display.

The control circuit 7 of the aerosol-generating display 1 includes a display driver 15, a communication interface, a controller (for example, a microprocessor or microcontroller), and a memory 17 to store data and images to be displayed by the, or each, display 12. The control circuitry 7 may be operatively coupled to one or more of the displays 12, to facilitate various functionality of the aerosol-generating display 1.

One or more of the controllers of the control circuitry 7 described herein may include a processor, such as a central processing unit (CPU), computer, logic array, or other device capable of directing data coming into or out of the aerosol-generating display 1. The controller includes one or more computing devices having memory, processing, and communication hardware. The functions of the controller may be performed by hardware and/or as computer instructions on a non-transient computer readable storage medium.

The processor of the controller may include any one or more of a microprocessor, a controller, a microcontroller, a digital signal processor (DSP), an application specific integrated circuit (ASIC), a field-programmable gate array (FPGA), and/or equivalent discrete or integrated logic circuitry. In some examples, the processor may include multiple components, such as any combination of one or more microprocessors, one or more controllers, one or more DSPs, one or more ASICs, and/or one or more FPGAs, as well as other discrete or integrated logic circuitry. The functions attributed to the controller or processor herein may be embodied as software, firmware, hardware, or any combination thereof. While described herein as a processor-based system, an alternative controller could utilize other components such as relays and timers to achieve the desired results, either alone or in combination with a microprocessor-based system.

The exemplary systems, methods, and interfaces may be implemented using one or more computer programs using a computing apparatus, which may include one or more processors and/or memory 17. Program code and/or logic described herein may be applied to input data/information to perform functionality described herein and generate desired output data/information on the, or each, display 12. It will be readily apparent that the controller functionality as described herein may be implemented in any manner known to one skilled in the art.

The control circuitry 7 may be used to enable various modes of the aerosol-generating device 1. One example includes a visual artistic effect on activation mode, in which a motion image may be shown on the display or displays 12, in response to activation of the system 1, for example, by the actuator or puff senor. Upon detecting a puff and optionally receiving a puff profile, the controller may collect a memory address associated with the visual artistic effect to be shown on the, or each, of the displays 12. Data associated with the visual artistic effect may be fetched from the memory at the memory address. The data may be used to display or show the visual artistic effect on the, or each, display 12.

Other image data, such as user information or user messages, may be retrieved in a similar manner, for example, in response to a user action other than puffing, i.e. in response to a change of orientation of the device, or in response to part of the display being covered.

In some embodiments, the or each display 12 can be a touch sensitive display, which can be enabled as a capacitive touch sensitive display, a resistive or a force sensing resistor display. A touch sensitive display can be used as a communication interface to display one or more user selectable elements in response to user touch. A touch sensitive display 12 on the aerosol-generating device 1 may further increase interaction, reconfigurability, and customization of sensory experiences offered by the aerosol-generating device 1. It is envisaged that graphics or information may be manipulated or moved across the display 12 in response to finger gestures, similar to that achievable using the display of often associated with a smartphone. A user may also be able to activate various functions of the device 1 by using the screen as an input, i.e. by making various gestures on the display 12, such as tapping or swiping. The touch sensitive component may be implemented using any suitable technique, such as capacitive touch sensitivity or resistive touch sensitivity.

According to certain embodiments, the control circuitry 7 is configured to detect an orientation of the device 1, and to control the display 12 such that a predetermined image, such as an image stored in the memory 17 of the device 1, is displayed. The control circuitry 7 can cause a different image to be displayed, depending on the orientation of the device 1 as detected by the control circuitry 7, or at least change at least a part of the look or appearance of the image being displayed, rather than change the entire image.

The control circuitry 7 may include a sensor 16 that is capable of detecting an orientation of the device 1, and the display driver 15 may receive a signal from the sensor which is indicative of the detected orientation of the device 1. The sensor 16 can be an accelerometer, or an accelerometer and a gyroscope that act in unison to determine the orientation of the device 1, as well as movement of the device 1 into different orientations.

As is known to persons skilled in the art, an accelerometer measures linear acceleration of movement and can be used to detect orientation, such as the orientation of a smartphone. A gyroscope adds an additional dimension to the information supplied by the accelerometer by tracking rotation or twist.

The display driver 15 may maintain an orientation of a predetermined image being displayed, irrespective of a change to the orientation of the device 1. This means that, even as the device 1 is moved by a user, the image or information being displayed stays in the same position or remains ‘the right way up’ and is essentially static, irrespective of whether the device 1 is moved between different orientations. In particular, if a user was to roll the device 1 between their fingers, the information on the display 1 may remain in the same orientation, i.e. the device 1 moves but the image remains substantially static.

The display driver 15 may change a predetermined image currently appearing on the display 12 for another predetermined image, depending on the orientation of the device 1.

Furthermore, the display driver 15 can be configured to deactivate the display 12 when the device 1 remains in the same orientation for a predetermined period of time. The display driver 15 can then re-activate the display 12 when the device 1 is picked up or moved, and its orientation changes.

The steps involved in a method of controlling a non-combustible aerosol-generating device according to above-described embodiment of the invention are illustrated in FIG. 4. The method of control involves detecting an orientation of the device in Step S1, and controlling the display, in Step S2, to display a predetermined image based on said detected orientation.

In addition to displaying an image based upon an orientation of the device 1, it is also envisaged that the control circuitry 7 can be configured to detect activated regions of the display 12 that are covered, and to deactivate those regions, thereby reducing power consumption. Therefore, in addition to changing the images being displayed based upon device orientation, the display driver 15 may also be configured to determine parts or regions of the display 12 that are covered, i.e. as a result of the device 1 being held in the hand of a user, or because the device 1 is partially or wholly received in a case or sleeve.

In certain embodiments, the display driver 15 of the control circuitry 7 can be configured to move images previously visible on activated regions of the display 12 prior to deactivation of said regions due to the display 12 being covered, to another region of the display 12 that remains exposed.

The display 12 may be touch sensitive, and the control circuitry 7 can be configured to deactivate regions of the display 12 being touched. Alternatively, the display 12 can include light sensors or be a light sensitive display. Furthermore, the control circuitry 7 can be configured to detect localised changes in temperature, which would occur as a result of the device 1 being held in the hand of a user, and to deactivate those regions of the display 12 which exceed a predetermined temperature. The control circuitry 7 can then be configured to deactivate regions of the display 12 when a predetermined minimum light level has been sensed over certain regions or parts of the display 12. If the display 12 comprises user selectable elements, they may also move from one part of a display 12 to another, or from one display 12 to another, based on the device orientation, i.e. so as to maintain the user selectable elements facing the user irrespective of device orientation.

In any embodiment, the device 1 may comprise a second display for displaying an image visible to a user on activated regions of the second display. There may also be multiple displays. The control circuitry 7 may then be configured to move images previously visible on activated regions of one display 12, prior to deactivation of said display 12 in response to being covered, to another display. The two displays 12 could each extend about part of the longitudinal axis of the housing 2, so as to form a “top” display 12, and a “bottom” display, when the device 1 is held in a normal, orientation in which it is used, i.e. in an orientation in which the longitudinal axis X-X is maintained substantially horizontal. Information may be transferred from the top display to the bottom display and vice-versa when the device is rolled or moved about said longitudinal axis.

Rather than deactivate regions of a display 12, the display driver 15 may just detect that a display 12 is being partly or wholly covered, and so deactivate the entire display 12, and move any images that had been displayed prior to deactivation, to another display 12.

The second or any other display 12 may also have regions that deactivate if they are covered, similar to the first display 12. For example, a second or any other display can be a touch sensitive display, and the control circuitry may be configured to deactivate regions of the second display being touched.

According to another embodiment, the control circuitry 7 can be configured to detect activated regions of the display 12 that are covered, and to deactivate said regions, i.e. without any change of images based on a detected orientation of the device 1.

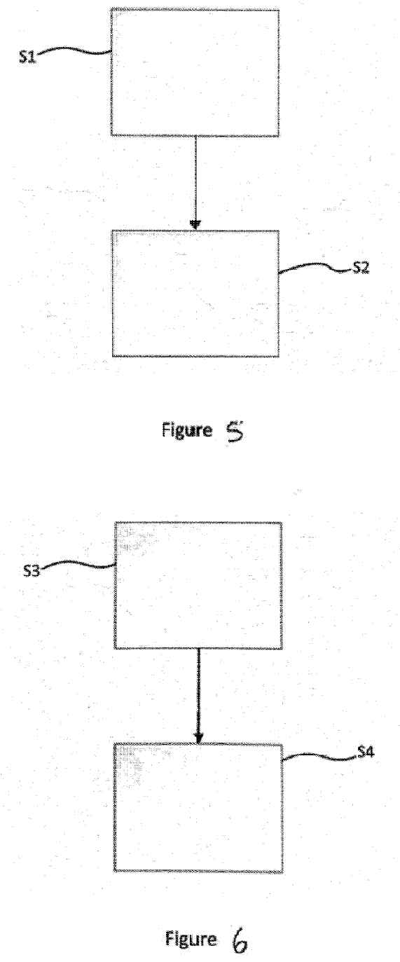

The steps involved in a method of controlling a non-combustible aerosol-generating device according to above-described embodiment of the invention are illustrated in FIG. 5. The method of control involves, in Step S3, detecting activated regions of the display that are covered, and deactivating said regions in Step S4.

It should be appreciated that while the above has focused, in part, on an aerosol-generating device of the “heat-not-burn” type, the principles described herein are not limited to aerosol-generating devices of this type. For instance, one or more displays 12 may be provided on an aerosol-generating devices configured to vaporise a liquid source (which may be achieved by vaporising a small amount of liquid extracted from a liquid reservoir containing a bulk liquid using a liquid transport element or wick). Such aerosol-generating devices are typically referred to as a vaping system or electronic nicotine delivery system (END). Such a system is formed of a device part and a cartridge (which is an example of a consumable part).

The cartridge part comprises a housing (e.g., formed of a plastic material), an aerosol-generating material storage area (or liquid reservoir), an aerosol-generating material transfer component (or wicking element, formed for example of a porous ceramic or bundle of fibres, such as cotton) arranged in fluid communication with the aerosol-generating material storage area, an aerosol generator (which may, for example, include a heating element, such as a resistance heating wire wrapped around the wicking element). The aerosol-generating material transfer component is arranged to provide aerosol-generating material (liquid) to the aerosol generator from the aerosol-generating material storage area. An air/aerosol pathway spans from an inlet of the cartridge to an outlet (which may correspond with a mouthpiece part of the cartridge, which in use, is intended to be inserted into the mouth of a user). The air/aerosol pathway passes alongside/in the vicinity of the aerosol generator, such that vapour generated from the aerosol generator may be entrained in air passing through the air/aerosol pathway in order to be delivered to the user. The area surrounding the aerosol-generator thereby forms an aerosol generation area. The device part comprises suitable components to enable and control the aerosol generation, e.g., such as an electronics/power chamber (similar to electronics/power chamber 6) containing electrical control circuitry (similar to electrical control circuitry 7) and a power source (similar to power source 8). Power may be provided from the device part to the consumable to cause the aerosol generator to generate aerosol (e.g., via passing a current through the aerosol generator via electrical contacts provided on the cartridge that engage with electrical contacts on the device part).

In accordance with the present disclosure, one or more displays may be provided on the device part of the aforementioned vaping system (in a substantially similar manner to that as described above with respect to the “heat-not-burn” system). In addition, or alternatively, the, or one or more, displays may be provided on the cartridge. The cartridge may be configured to receive an electrical input from the device part to control the one or more displays (if present) on the cartridge. Alternatively, the cartridge may be provided with its own power source and/or controller for controlling the one or more displays (if present) on the cartridge.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A non-combustible aerosol-generating device, comprising:
a display for displaying a predetermined image visible to a user on activated regions of the display, and
control circuitry configured to detect an orientation of the aerosol-generating device, and to control the display such that a predetermined image is displayed based on said detected orientation.

2. A non-combustible aerosol-generating device according to claim 1, wherein the control circuitry comprises a sensor to detect an orientation of the aerosol-generating device, and a display driver configured to receive a signal from the sensor indicative of said detected orientation and to display a predetermined image based on said signal.

3. (canceled)

4. (canceled)

5. A non-combustible aerosol-generating device according to claim 2, wherein the sensor and the display driver are configured to maintain the orientation of a predetermined image being displayed, irrespective of a change to the orientation of the aerosol-generating device.

6. A non-combustible aerosol-generating device according to claim 2, wherein the display driver is configured to change a predetermined image being displayed for another predetermined image, based on a detected change in the orientation of the aerosol-generating device.

7. A non-combustible aerosol-generating device according to claim 2, wherein the display driver is configured to deactivate the display when the aerosol-generating device remains in the same orientation for a predetermined period of time.

8. A non-combustible aerosol-generating device according to claim 7, wherein the display controller is configured to reactivate the display, to display a predetermined image based on said detected orientation of the aerosol-generating device, when the orientation of the aerosol-generating device changes from said same orientation.

9. A non-combustible aerosol-generating device, according to claim 1, wherein the control circuitry is configured to detect activated regions of the display that have been covered, and to deactivate said regions.

10. A non-combustible aerosol-generating device, according to claim 9, wherein the control circuitry is configured to move images previously visible on activated regions of the display prior to deactivation of said regions, to another, exposed, region of the display.

11. A non-combustible aerosol-generating device, according to claim 9, wherein the display is a touch sensitive display, the control circuitry being configured to deactivate regions of the display being touched.

12. A non-combustible aerosol-generating device, according to claim 10, wherein the display is a light sensitive display, and the control circuitry is configured to deactivate regions of the display when a predetermined minimum light level has been sensed.

13. A non-combustible aerosol-generating device according to claim 9, comprising a second display for displaying an image visible to a user on activated regions of said second display.

14. A non-combustible aerosol-generating device according to claim 13, wherein the display driver is configured to move images previously visible on activated regions of the display, prior to deactivation of said display in response to being covered, to said second display.

15. A non-combustible aerosol-generating device according to claim 14, wherein the control circuitry is configured to completely deactivate the display when activated regions of the display are covered, such that images are displayed only on the second display.

16. A non-combustible aerosol-generating device according to claim 13, wherein the control circuitry is configured to detect activated regions of the second display that are covered, and to deactivate said covered regions of the second display.

17. (canceled)

18. (canceled)

19. A non-combustible aerosol-generating system comprising a non-combustible aerosol-generating device according to claim 1, and a non-combustible aerosol-generating article receivable in the non-combustible aerosol-generating device.

20. A method of controlling a non-combustible aerosol-provision device according to claim 1, comprising:
detecting an orientation of the aerosol-generating device, and
controlling the display to display a predetermined image based on said detected orientation.

21. A non-combustible aerosol-generating device, comprising:
a display for displaying an image visible to a user on activated regions of the display, and
control circuitry to control the display,
wherein the control circuitry is configured to detect activated regions of the display that are covered, and to deactivate said regions.

22. A non-combustible aerosol-generating device according to claim 1, comprising a housing having an outer surface, and wherein the display is attached to said outer surface.

23. A non-combustible aerosol-generating device according to claim 22, wherein the outer surface of the housing comprises a contoured shape and the display is configured so that it conforms to the contoured shape of the outer surface of the housing.

24. (canceled)

25. A method of controlling a non-combustible aerosol-generating device, according to claim 1, comprising:
detecting activated regions of the display that are covered, and deactivating said regions.
